(19) United States
(12) Patent Application Publication
(10) Pub. No.: US 2026/0093772 A1
(43) Pub. Date: Apr. 2, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Shigeo KODAMA, Tokyo (JP)

(21) Appl. No.: 19/335,071

(22) Filed: Sep. 22, 2025

(30) Foreign Application Priority Data
Sep. 30, 2024 (JP) 2024-171515
Jul. 7, 2025 (JP) 2025-114641

(51) Int. Cl. G06F 17/15; G06F 5/01

(52) U.S. Cl. CPC G06F 17/15; G06F 5/01

(57) ABSTRACT

An information processing apparatus comprises a processing unit configured to perform convolution computation of feature data and coefficient data, and calculation of statistics of the feature data, and a post-processing unit configured to normalize a result of the convolution computation based on the result and the statistics.

### BACKGROUND

### Field of the Technology

The present disclosure relates to a convolution computation technique.

### Description of the Related Art

Hierarchical computation methods represented by convolutional neural networks (hereinafter referred to as CNNs) have been widely used. For example, “Simple Baselines for Image Restoration” by Liangyu Chen, Xiaojie Chu, Xiangyu Zhang, and Jian Sun, presented at European Conference on Computer Vision, 2022 discloses the network structure of a baseline that performs image data restoration (such as denoising and image stabilization) with high calculation efficiency.

In CNNs such as those described above, by normalizing feature data through layer normalization using a deep learning technology during training of convolutional weights, the training is accelerated and stabilized. In layer normalization, the means and variances of feature data are used, but techniques such as that disclosed in Japanese Patent Laid-Open No. 2006-244076 are disclosed as methods for calculating variances.

To perform inference using a model that repeats layer normalization and convolution computation, it has been necessary to repeat a process of normalizing feature data that has been input for layer normalization, and obtaining a convolution computation result using the normalized feature data as input for convolution computation. In this case, it has been necessary to transfer the normalized feature data to a large-capacity storage device and transfer the normalized feature data from the storage device to a convolution computation unit before performing convolution computation, thus consuming significant bandwidth. Alternatively, to store normalized feature data in a dedicated memory and supply the normalized feature to a convolution computation unit via this memory, the capacity of the dedicated memory has been increased.

### SUMMARY

The present disclosure provides a technique for more efficiently obtaining a normalization result of a convolution computation result.

According to the first aspect of the present disclosure, there is provided an information processing apparatus comprising: a processing unit configured to perform convolution computation of feature data and coefficient data, and calculation of statistics of the feature data; and a post-processing unit configured to normalize a result of the convolution computation based on the result and the statistics.

According to the second aspect of the present disclosure, there is provided an information processing method that is performed by an information processing apparatus, comprising: performing convolution computation of feature data and coefficient data, and calculation of statistics of the feature data; and normalizing a result of the convolution computation based on the result and the statistics.

According to the third aspect of the present disclosure, there is provided a non-transitory computer-readable storage medium storing a program for causing a computer to function as: a processing unit configured to perform convolution computation of feature data and coefficient data, and calculation of statistics of the feature data; and a post-processing unit configured to normalize a result of the convolution computation based on the result and the statistics.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an exemplary hardware configuration of an information processing apparatus.

FIG. 2 is block diagram showing an exemplary hardware configuration of a CNN computation unit 101.

FIG. 3A is a flowchart of a NAFNet model.

FIG. 3B is a flowchart of the NAFNet model.

FIG. 4 is a block diagram showing an exemplary configuration of a computation unit 203 and a statistics calculation unit 206.

FIG. 5A is a diagram illustrating the transfer order of feature maps and feature data.

FIG. 5B is a diagram showing the transfer order of feature maps and feature data.

FIG. 6 is a block diagram showing an exemplary configuration of a post-processing unit 207.

FIG. 7 is a block diagram showing an exemplary hardware configuration of a CNN computation unit 101.

FIG. 8 is a diagram illustrating processing that is performed on consecutive frame images.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

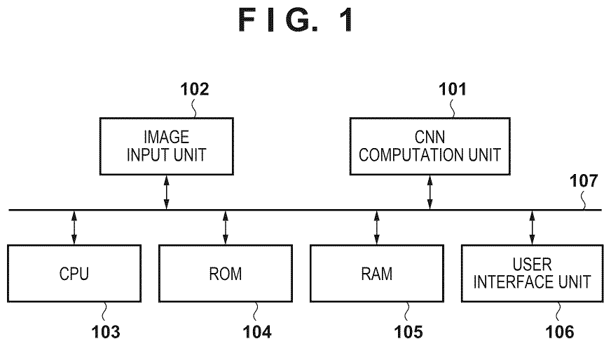

In the present embodiment, a nonlinear activation free network (NAFNet) model for restoring input image data, which is described in “Simple Baselines for Image Restoration” by Liangyu Chen, Xiaojie Chu, Xiangyu Zhang, and Jian Sun, presented at European Conference on Computer Vision, 2022, is used as an example of a hierarchical neural network. In addition, in the present embodiment, a case will be described in which inference using the NAFNet model is performed by an information processing apparatus that functions as a CNN accelerator. First, an exemplary hardware configuration of an information processing apparatus according to the present embodiment will be described with reference to the block diagram in FIG. 1.

A CNN computation unit 101 performs inference using the NAFNet model. An image input unit 102 is either a still image capturing unit that periodically or non-periodically captures still images, or a moving image capturing unit that captures moving images. If the image input unit 102 is a still image capturing unit, the image input unit 102 outputs a captured still image as an input image. If the image input unit 102 is a moving image capturing unit, the image input unit 102 outputs the image of each frame in a captured moving image as an input image.

The image input unit 102 includes, for example, an optical system such as a lens, a photoelectric conversion device such as a charge-coupled device (CCD) or complementary metal-oxide-semiconductor (CMOS) sensor, a driver circuit for controlling the photoelectric conversion device, and an A/D converter.

The CNN computation unit 101 performs inference on an input image output from the image input unit 102, using the NAFNet model, thereby executing image processing such as noise reduction and image stabilization on the input image.

A central processing unit (CPU) 103 executes various types of processing using computer programs and data stored in a random access memory (RAM) 105. Accordingly, the CPU 103 performs overall operation control of the information processing apparatus and also executes or controls various types of processing described as processing that is performed by the information processing apparatus.

A read-only memory (ROM) 104 stores setting data for the information processing apparatus, computer programs and data related to the startup of the information processing apparatus, and computer programs and data related to basic operations of the information processing apparatus. The ROM 104 also stores computer programs and data for causing the CPU 103 and the CNN computation unit 101 to execute or control various types of processing described as processing that is performed by the information processing apparatus.

The RAM 105 can be constituted by a large-capacity dynamic random access memory (DRAM) and the like. The RAM 105 includes an area for storing computer programs and data loaded from the ROM 104, and an area for storing input images output from the image input unit 102. The RAM 105 also includes a work area that is used when the CPU 103 and the CNN computation unit 101 execute various types of processing. In this manner, the RAM 105 can provide various areas as appropriate.

The CNN computation unit 101 executes CNN computation specified in accordance with an instruction from the CPU 103, and stores, in the RAM 105, intermediate feature data generated during the CNN computation, and an image that is an output result.

A user interface unit 106 is a user interface such as a keyboard or mouse, and the user can input various instructions and information to the information processing apparatus by performing an operation on the user interface unit 106. Note that the user interface unit 106 may include a display device that has an LCD screen or a touch panel screen.

For example, the user selects, using the user interface unit 106, processing to be executed by the CNN computation unit 101, by performing an operation on a graphical user interface (GUI) displayed on the user interface unit 106.

The CNN computation unit 101, the image input unit 102, the CPU 103, the ROM 104, the RAM 105, and the user interface unit 106 are all connected to a data bus 107. The data bus 107 is a data transfer path between devices.

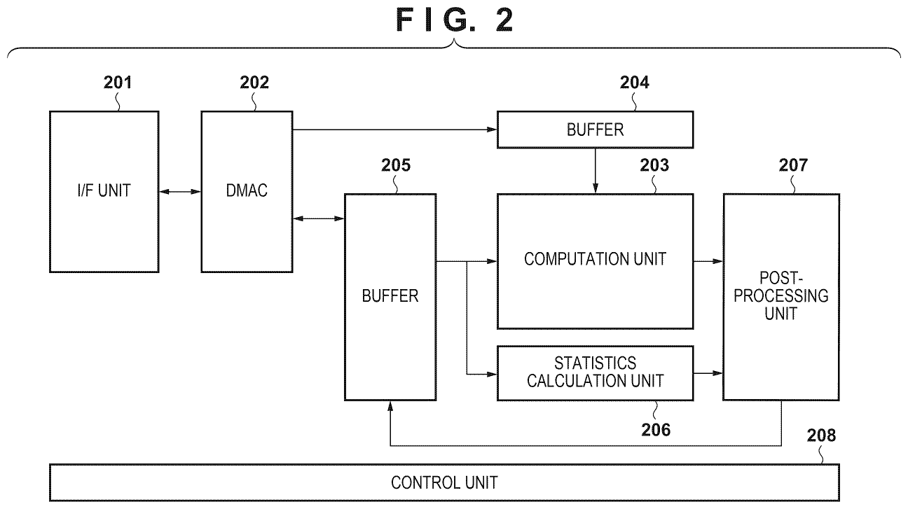

Next, an exemplary hardware configuration of the above CNN computation unit 101 will be described with reference to the block diagram in FIG. 2. An I/F unit 201 functions as an interface for enabling data communication between the CPU 103 and a direct memory access controller (DMAC) 202 and control unit 208 via the data bus 107.

The DMAC 202 functions as a controller for data transfer between the CNN computation unit 101 and the RAM 105. The computation unit 203 performs convolution computation by referencing coefficient data for each layer of the NAFNet model (coefficient data that is used in a plurality of hierarchical computations) stored in a buffer 204, and feature data (an input image or a computation result of a layer preceding a layer that is a processing target) stored in a buffer 205.

The buffer 204 supplies coefficient data to the computation unit 203 with low latency. The buffer 204 includes, for example, a high-speed static RAM (SRAM) and register. Here, the coefficient data is coefficient data obtained by combining, in advance, coefficient data obtained through machine learning for convolution computation and coefficient data obtained through machine learning for layer normalization.

The buffer 205 stores input images, computation results obtained by the computation unit 203, and processing results obtained by the post-processing unit 207, and includes, for example, a high-speed SRAM and register, similarly to the buffer 204.

A statistics calculation unit 206 calculates statistics of the feature data stored in the buffer 205. To adjust the output range of a computation result obtained by the computation unit 203, the post-processing unit 207 adds a bias value to the computation result or multiplies the computation result by a gamma value, for example. The control unit 208 performs overall operation control of the CNN computation unit 101. The control unit 208 is constituted by a sequencer for controlling the computation unit 203, a simple CPU, and the like.

Assuming that the kernel (filter coefficient matrix) size for convolution computation is columnSize×rowSize, and the number of feature maps in the previous layer (the layer preceding a layer that is a processing target) is C, the computation unit 203 calculates one piece of feature data through convolution computation using Expression (1) below.

$$output ( x , y , c ) = {\sum }_{c = 1}^{C} {\sum }_{row = - \frac{rowSize}{2}}^{\frac{rowSize}{2}} {\sum }_{column = - \frac{columnSize}{2}}^{\frac{columnSize}{2}} input ( x + column , y + row , c ) \times weight ( column , row , c ) + bias ( c ) \qquad ( 1 )$$

input (x,y,c): a reference pixel value at a two-dimensional coordinate (x, y) and the feature map index c output (x,y,c): a computation result at the two-dimensional coordinate (x, y) and the feature map index c weight (column, row, c): coefficient data at a coordinate (x+column, y+row) and the feature map index c (obtained through machine learning) bias (c): addition value at the feature map index c (obtained through machine learning) C: the number of feature maps in the previous layer columnSize: the horizontal size of a two-dimensional convolution computation kernel rowSize: the vertical size of the two-dimensional convolution computation kernel

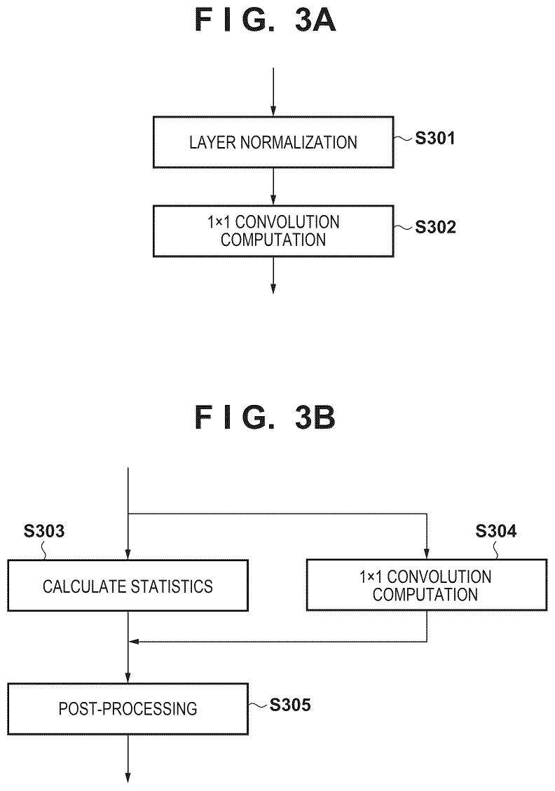

In general, in CNN computation processing, a multiply-accumulate operation is repeatedly performed while scanning a plurality of scanning convolution computation kernels in the units of pixels of an input image based on Expression (1) above, to calculate a feature map. On the other hand, in the NAFNet model, layer normalization in step S301 and 1×1 convolution computation in step S302, such as those shown in FIG. 3A, are repeatedly executed. In the layer normalization in step S301, normalization of feature data is performed based on the computation represented by Expression (2) below.

$$output ( x , y , c ) = γ ( c ) \frac{input ( x , y , c ) - μ ( x , y )}{\sqrt{{σ ( x , y )}^{2} + ϵ}} + β ( c ) \qquad ( 2 )$$

input (x,y,c): a reference pixel value at the two-dimensional coordinate (x,y) and the feature map index c output (x,y,c): a computation result at the two-dimensional coordinate (x,y) and the feature map index c μ (x,y): the mean value at the two-dimensional coordinate (x,y) σ (x,y)²: the variance value at the two-dimensional coordinate (x,y) ε: a fixed value for preventing division by zero γ (c): a normalized variance value at the feature map index c (obtained through machine learning) β (c): a normalized mean value at the feature map index c (obtained through machine learning)

In the layer normalization in step S301, training can be accelerated and stabilized by replacing the mean and variance of a population to be subjected to normalization (here, pixel values for which the two-dimensional coordinates are at the same position and the feature map indexes are 1 to C) with the variance value γ and the mean value β determined through training.

In contrast, in the present embodiment, normalized feature data is obtained by performing processing based on the processing flow shown in FIG. 3B instead of the processing flow shown in FIG. 3A. Note that statistics calculation in step S303 and 1×1 convolution computation in step S304 can be performed on the same feature map.

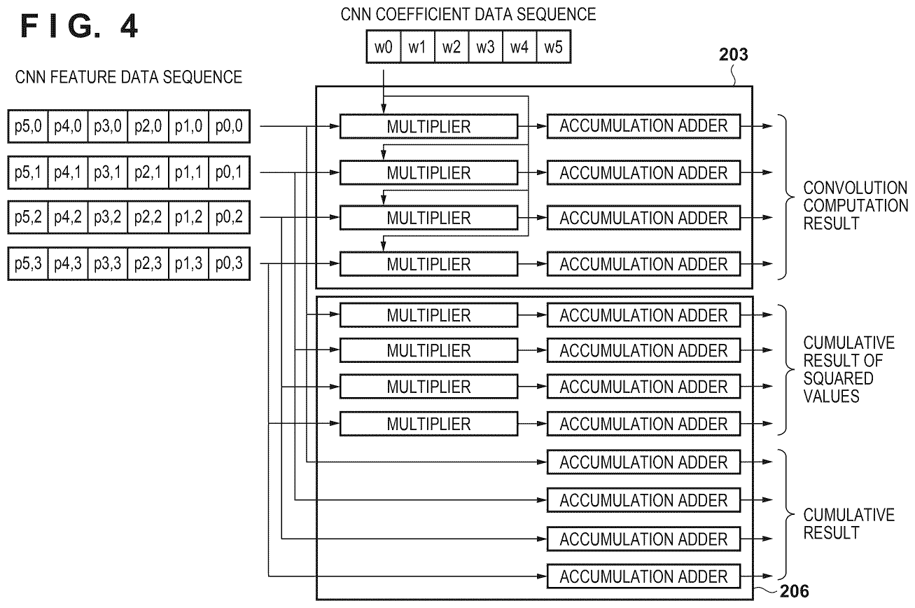

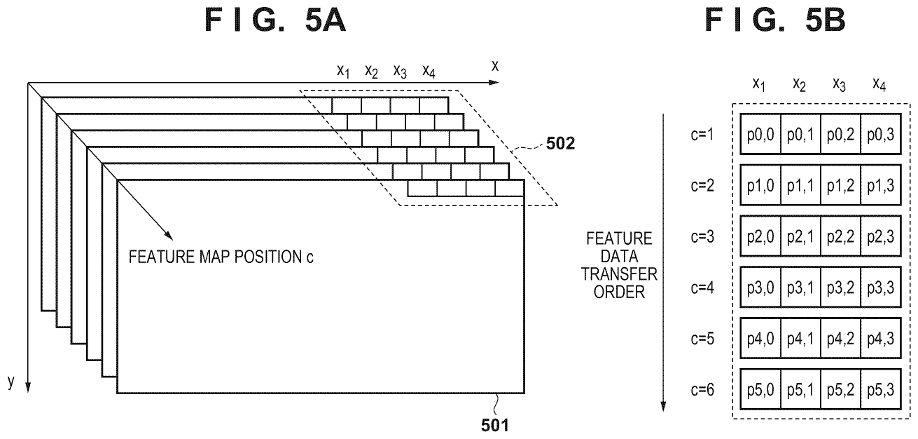

A configuration example of the computation unit 203 and the statistics calculation unit 206 will be described with reference to the block diagram in FIG. 4. The computation unit 203 includes multipliers and accumulation adders, and executes convolution computation of Expression (1) above in step S304. Each multiplier performs multiplication between a feature data sequence supplied from the buffer 205 and a coefficient data sequence supplied from the buffer 204. Spatially continuous feature data sequences 502, which are part of feature maps 501 stored in the RAM 105 and shown in FIG. 5A, are transferred from the RAM 105 to the buffer 205 via the DMAC 202, and are then supplied from the buffer 205 to the computation unit 203. Coefficient data sequences are similarly transferred from the RAM 105 to the buffer 204 via the DMAC 202, and a necessary coefficient data sequence is supplied from the buffer 204 to the computation unit 203. FIG. 5B shows how the feature data sequences 502 are sequentially transferred to the computation unit 203, but, in the case of convolution computation with a filter coefficient size of 1×1, coefficient data is supplied to the computation unit 203 in accordance with feature map indexes (indicated by numerical reference “c” in the figure). Each accumulation adder accumulates multiplication results obtained by the corresponding multiplier, and outputs, as a convolution computation result, a result of performing accumulation for all the feature maps.

The statistics calculation unit 206 includes squaring units and accumulation adders, and, in step S303, calculates two types of statistics related to the feature data. The first type of statistic related to the feature data is a cumulative result of the squared values of the feature data. Regarding the cumulative result of the squared values of the feature data, the squared values of the feature data are calculated by the squaring units and the squared values are accumulated for all the feature maps by the accumulation adders, to obtain the cumulative result of the squared values at the coordinate (x, y) on the feature maps. The second type of statistic related to the feature data is a cumulative result of the feature data. The cumulative result of the feature data can be obtained by accumulating the feature data at the coordinates (x, y) on all of the feature maps. These two types of statistics are used by the post-processing unit 207 to calculate the mean value and variance value of the feature data.

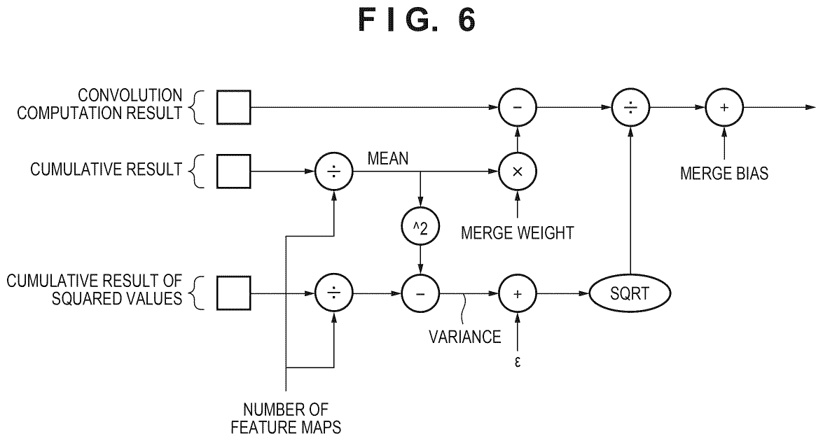

Next, a configuration example of the post-processing unit 207 will be described with reference to the block diagram in FIG. 6. FIG. 6 shows a configuration example for calculating a convolution computation result for one of the pixels that are processed in parallel in step S305. Although the other pixels are processed in parallel, a description thereof is omitted since the processing can be performed with a similar configuration.

The cumulative result obtained by the statistics calculation unit 206 is divided by the number of feature maps to obtain the mean value of the feature data. In addition, the variance value of the feature data can be obtained by dividing the cumulative result of the squared values by the number of feature maps and subtracting, from the result of the division, the square of the average value of the feature data. From the convolution computation result obtained by the computation unit 203, the average value of the feature data multiplied by a merge weight, the calculation method of which will be described later, is subtracted. Furthermore, a fixed value & is added to the variance value of the feature data, the square root of the result of the addition is calculated, the convolution computation result is then divided by this square root value, and a merge bias, the calculation method of which will be described later, is added. By performing such processing, it is possible to obtain a result equivalent to a result obtained by sequentially executing the layer normalization in step S301 and the 1×1 convolution computation in step S302, which are shown in FIG. 3A.

This result can be derived using Expressions (1) and (2) above. First, the convolution computation represented by Expression (1) is generalized with respect to the filter size, and thus is rewritten into Expression (3) below using a 1×1 filter size to simplify the description.

$$output ( x , y , c ) = {\sum }_{c = 1}^{C} input ( x , y , c ) \times weight ( c ) + bias ( c ) \qquad ( 3 )$$

input (x,y,c): a reference pixel value at the two-dimensional coordinate (x,y) and the feature map index c output (x,y,c): a computation result at the two-dimensional coordinate (x,y) and the feature map index c weight (c): coefficient data at the feature map index c (obtained through machine learning) bias (c): the added value at the feature map index c (obtained through machine learning) C: the number of feature maps in the previous layer By substituting “output” of the layer normalization represented by Expression (2) above into “input” of the convolution computation represented by Expression (3) above, the following formula is obtained.

$$output ( x , y , c ) = {\sum }_{c = 1}^{C} \{ ( γ ( c ) \frac{input ( x , y , c ) - μ ( x , y )}{\sqrt{{σ ( x , y )}^{2} + ϵ}} + β ( c ) ) \times weight ( c ) \} + bias ( c )$$

By transforming this formula, Expression (4) below is obtained.

$$output ( x , y , c ) = \{ {\sum }_{c = 1}^{C} ( weight ( c ) * γ ( c ) * input ( x , y , c ) ) - μ ( x , y ) {\sum }_{c = 1}^{C} ( weight ( c ) * γ ( c ) ) \} / \sqrt{{σ ( x , y )}^{2} + ϵ} + {\sum }_{c = 1}^{C} ( weight ( c ) * β ( c ) ) + bias ( c ) \qquad ( 4 )$$

Here, the following variables are defined.

$${weight}^{′} ( c ) = weight ( c ) * γ ( c ) \qquad ( 5 )$$

$$merge weight = {\sum }_{c = 1}^{C} ( weight ( c ) * γ ( c ) ) \qquad ( 6 )$$

$$merge bias = {\sum }_{c = 1}^{C} ( weight ( c ) * β ( c ) ) + bias ( c ) \qquad ( 7 )$$

Using Expressions (5), (6), and (7) above, Expression (4) above is expressed as Expression (8) below.

$$output ( x , y , c ) = \{ {\sum }_{c = 1}^{C} ( {weight}^{′} ( c ) * input ( x , y , c ) ) - μ ( x , y ) * merge weight \} / \sqrt{{σ ( x , y )}^{2} + ϵ} + merge bias \qquad ( 8 )$$

Based on Expression (5) above, “weight” for 1×1 convolution computation and y for layer normalization, which have been originally obtained through machine learning, are calculated in advance before performing inference, and thereby “weight” can be obtained. When “weight′” is considered as coefficient data, the first term in Expression (8) represents 1×1 convolution computation. In addition, the merge weight that is multiplied by the mean value of the feature data, and the merge bias that is added to the entire feature data can also be calculated using Expressions (6) and (7) in advance, respectively. The merge weight can be regarded as the sum of “weight′” calculated based on Expression (5). The merge bias can be calculated by multiplying “weight” for 1×1 convolution computation originally obtained through machine learning by β for layer normalization originally obtained through machine learning, summing multiplication results, and then adding the bias value of an output channel. In addition, since the merge weight is a common value regardless of a feature map index, and the merge bias replaces “bias” originally calculated through machine learning, the storage area for storing coefficients does not increase.

Therefore, Expression (8), which can yield a result equivalent to that of convolution computation following layer normalization, can be processed by the computation unit 203, the statistics calculation unit 206, and the post-processing unit 207, which have been described above.

As described above, in the present embodiment, statistics of feature data are calculated in parallel with performing convolution computation using the same feature data and coefficient data, and thereby a convolution computation result normalized through layer normalization is obtained from a result of the convolution computation and the statistics.

Conventionally, in a processing flow in which layer normalization is performed and convolution computation is then executed, it has been necessary to temporarily transfer feature data subjected to layer normalization, to a large-scale storage medium such as a RAM. In addition, when performing convolution computation, the normalized feature data is read out from the storage medium and is processed, resulting in an increased bandwidth usage and processing time between the storage medium and the computation unit. Alternatively, a configuration is conceivable in which feature data subjected to layer normalization is stored in a dedicated memory and the feature data stored in the dedicated memory is used by the computation unit, without transferring the feature data to an external storage medium, but this configuration increases the cost due to the need to prepare for the dedicated memory.

In contrast, in the present embodiment, resources required for reading feature data in layer normalization and convolution computation are consolidated, such that computation required for layer normalization and convolution computation can be performed in parallel with a single read operation, and thus efficient processing can be realized.

In addition, the division by the square root of the variance value in Expression (8) can be performed at a high speed using a technique called the fast inverse square root, one-dimensional interpolation that uses a lookup table, or the like.

Note that, in the present embodiment, a description has been given on layer normalization and convolution computation of the NAFNet model to which the present embodiment is applied, while a description of other layer processing has been omitted. When executing the entire processing of the NAFNet model, desired computation may be repeatedly performed using the computation unit and post-processing unit described in the present embodiment, or high-speed processing may be performed by adding a dedicated processing element.

Note that, in the present embodiment, although an example of convolution computation that uses a filter coefficient size of 1×1 has been described above as convolution computation, the present embodiment can also be applied to convolution computation that uses a filter coefficient size of 3×3 or 5×5. In such a case, it is sufficient that the transfer amount of feature data that is supplied from the buffer 205 to the computation unit 203 is changed in accordance with the filter coefficient size. Also, by changing the amount of feature data that is supplied from the buffer 205 based on the unit by which normalization is performed, the statistics calculation unit 206 can change the unit by which normalization is performed, not only through layer normalization. When the processing ranges of feature data required for the computation unit 203 and the statistics calculation unit 206 are different, the present embodiment can be applied by transferring the feature data of the larger range, and causing the computation unit 203 and the statistics calculation unit 206 to process only a required region.

### Second Embodiment

In the present embodiment, an embodiment will be described for a case where data is referenced differently between convolution computation and layer normalization. Particularly, an example will be described in which, when frame images are processed in a continuous manner as with video image data, convolution computation with a filter coefficient size of 1×1 and layer normalization applied to the entire feature data are efficiently implemented. Note that a description of configurations that do not differ from those in the first embodiment is omitted.

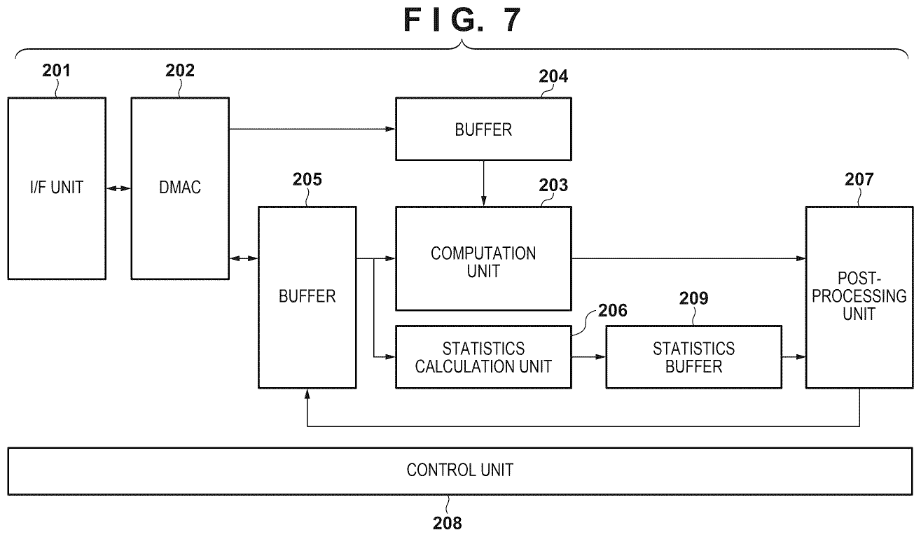

An exemplary hardware configuration of the CNN computation unit 101 according to the present embodiment will be described with reference to FIG. 7. The difference from the exemplary hardware configuration shown in FIG. 2 is that a statistics buffer 209 is provided between the statistics calculation unit 206 and the post-processing unit 207.

The statistics buffer 209 stores the statistics data for each layer when consecutive frame images are processed, and supplies the statistics data to the post-processing unit 207.

In layer normalization according to the present embodiment, feature data is normalized based on Expression (9) below.

$$output ( x , y , c ) = γ ( c ) \frac{input ( x , y , c ) - μ}{\sqrt{{σ}^{2} + ε}} + β ( c ) \qquad ( 9 )$$

input (x,y,c): a reference pixel value at the two-dimensional coordinate (x,y) and the feature map index c output (x,y,c): a computation result at the two-dimensional coordinate (x,y) and the feature map index c μ: the mean value of the entire feature data σ²: the variance value of the entire feature data E: a fixed value for preventing division by zero γ (c): a normalized variance value at the feature map index c (obtained through machine learning) β (c): a normalized mean value at the feature map index c (obtained through machine learning)

The difference from Expression (2) is that the unit by which the mean value μ and the variance value σ² of the feature data are obtained is different, and the entire feature data is processed in Expression (9). Therefore, the reference range of feature data differs from that in the 1×1 convolution computation represented by Expression (3). An operation example in this case will be described below.

Similarly to the first embodiment, a convolution computation unit 203 performs convolution computation on the feature data supplied from a CNN feature buffer 205 and corresponding to feature map indexes 1 to c, and outputs the resultant to the post-processing unit 207. The statistics calculation unit 206 accumulates statistics of the feature data supplied from the CNN feature buffer 205 and corresponding to the feature map indexes 1 to c, and then continues to accumulate statistics of feature data corresponding to the next two-dimensional coordinates as well. Once the statistics have been calculated for the entire feature data, statistical data, which is data of statistics, is transmitted to the statistics buffer 209, and is stored in the statistics buffer 209. The statistics buffer 209 supplies statistical data of a layer undergoing convolution computation, out of the statistical data stored therein, to the post-processing unit 207. Using a similar method as in the first embodiment, the post-processing unit 207 generates a 1×1 convolution computation result subjected to layer normalization.

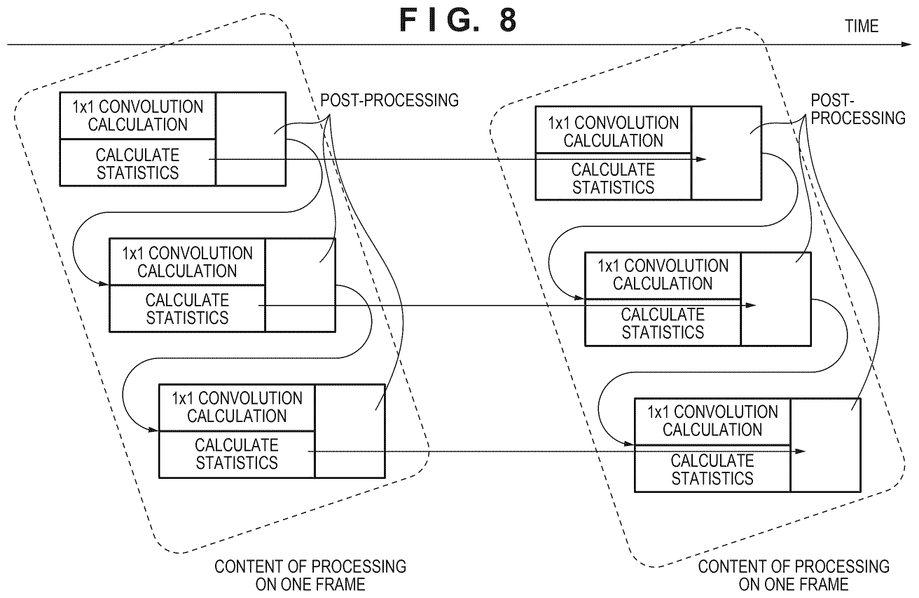

Processing that is performed on consecutive frame images will be described with reference to FIG. 8. In FIG. 8, CNN processing is envisioned, in which layer processing for performing 1×1 convolution computation and layer normalization (separated into statistics calculation and post-processing) is implemented for three layers, and this processing is performed on consecutive frame images. As described above, in the present embodiment, the data reference ranges for the 1×1 convolution computation and for the statistics calculation differ, making it impossible to calculate a 1×1 convolution computation result and a statistics calculation result simultaneously. However, the feature data of frame images exhibits a high degree of similarity, and this tendency is more significant for feature data of frame images that are temporally close to each other. In addition, the statistics of the entire feature data are rounded to erase detailed data, and thus, using the statistics of a nearby frame does not affect the accuracy of CNN computation. Therefore, in processing that is performed on consecutive frame images, the statistics calculation result calculated for a previous frame for each layer is referenced to perform post-processing on the 1×1 convolution computation result. Accordingly, in processing of each frame image, feature data needs to be referenced only once, which enables efficient processing.

### Third Embodiment

In the first and second embodiments, a case has been described in which computation processing such as convolution computation and layer normalization is executed using the CNN computation unit 101 that is hardware. However, such computation processing may alternatively be executed using a processor such as a CPU, a graphics processing unit (GPU), or a digital signal processing unit (DSP). In addition, such computation processing may be executed through a cooperative operation between a processor and hardware such as the CNN computation unit 101.

In addition, in the first and second embodiments, a case has been described in which the image input unit 102 is an image capturing unit that captures still images or moving images, but the method for obtaining an input image is not limited to image capturing, and thus the image input unit 102 does not need to be an image capturing unit. For example, the image input unit 102 may be a device that reads input images from a storage device such as a hard disk drive device, or a device that downloads input images from an external server apparatus.

In addition, in the first and second embodiments, a case has been described in which all of the functional units shown in FIG. 2 are implemented as hardware, but some of the functional units may be implemented as software (computer programs). For example, the computation unit 203, the statistics calculation unit 206, and the post-processing unit 207 may be implemented as software. In this case, the functions of the corresponding functional units are realized by the control unit 208 or the CPU 103 executing this software.

The numerical values, processing timings, processing orders, processing entities, and the configurations, obtaining methods, transmission destinations, transmission sources, and storage locations of data (information), which are used in the above embodiments, are merely examples provided to give a specific description, and are not intended to be limiting.

In addition, some or all of the embodiments described above may be combined as appropriate. In addition, some or all of the embodiments described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-171515, filed Sep. 30, 2024, and Japanese Patent Application No. 2025-114641, filed Jul. 7, 2025 which are hereby incorporated by reference herein in their entirety.

What is claimed is:

1. An information processing apparatus comprising:
a processing unit configured to perform convolution computation of feature data and coefficient data, and calculation of statistics of the feature data; and
a post-processing unit configured to normalize a result of the convolution computation based on the result and the statistics.

2. The information processing apparatus according to claim 1,
wherein the processing unit executes the convolution computation and the calculation of statistics on the same feature data in parallel.

3. The information processing apparatus according to claim 1,
wherein the post-processing unit calculates a convolution computation result subjected to layer normalization, based on the result of the convolution computation and the statistics.

4. The information processing apparatus according to claim 1,
wherein the convolution computation is convolution computation that uses a filter coefficient size of 1×1.

5. The information processing apparatus according to claim 1,
wherein the statistics include a cumulative result of the feature data and a cumulative result of squared values of the feature data.

6. The information processing apparatus according to claim 5,
wherein the post-processing unit calculates a mean value based on the cumulative result of the feature data, and calculates a variance value of the feature data based on the cumulative result of the squared values of the feature data and the mean value.

7. The information processing apparatus according to claim 1,
wherein the coefficient data is coefficient data obtained by combining, in advance, coefficients obtained through machine learning for convolution computation and coefficients obtained through machine learning for layer normalization.

8. The information processing apparatus according to claim 3,
wherein the post-processing unit calculates a convolution computation result subjected to layer normalization by using a value obtained by combining, in advance, coefficients obtained through machine learning.

9. The information processing apparatus according to claim 1, further comprising:
a buffer for storing the feature data and a buffer for storing the coefficient data.

10. The information processing apparatus according to claim 1,
wherein, in processing that is performed on consecutive frame images, the post-processing unit normalizes a convolution computation result obtained from a current frame image based on statistics obtained from a past frame image and the convolution computation result.

11. An information processing method that is performed by an information processing apparatus, comprising:
performing convolution computation of feature data and coefficient data, and calculation of statistics of the feature data; and
normalizing a result of the convolution computation based on the result and the statistics.

12. A non-transitory computer-readable storage medium storing a program for causing a computer to function as:
a processing unit configured to perform convolution computation of feature data and coefficient data, and calculation of statistics of the feature data; and
a post-processing unit configured to normalize a result of the convolution computation based on the result and the statistics.
